(19) United States
(12) Patent Application Publication
(10) Pub. No.: US 2003/0203832 A1
(43) Pub. Date: Oct. 30, 2003

(54) Low organic spray drying process and composition formed thereby

(75) Inventors: Jeffrey Edward Boucher, Beijing (CN); Rui Shen, Beijing (CN); Kaiming Zhu, Beijing (CN)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/414,534

(22) Filed: Apr. 15, 2003

Related U.S. Application Data
(60) Provisional application No. 60/376,027, filed on Apr. 26, 2002.

(51) Int. Cl. C11D 17/00

(52) U.S. Cl. 510/443; 510/452

(57) ABSTRACT

An improved process having the steps of forming a low organic slurry in a mixer, pumping the low organic slurry to a spray drying tower, spraying the low organic slurry in the spray drying tower, drying the low organic slurry in the spray drying tower to form a low organic granule, and processing the low organic granule to form a detergent composition. The low organic slurry contains less than about 10%, by weight of the low organic slurry, of an organic material.

### CROSS REFERENCE TO RELATED APPLICATION

This application claims the benefit of U.S. Provisional Application No. 60/376,027, filed Apr. 26, 2002.

### FIELD OF INVENTION

The present invention relates to a spray drying process and a composition produced by this process. Specifically, the present invention relates to a spray drying process used to form a detergent granule and a subsequent detergent composition.

### BACKGROUND OF THE INVENTION

Spray drying processes for forming detergent compositions are well known in the art and have typically involved the steps of forming a detergent slurry by mixing a builder, a neutralized or acid-form anionic surfactant, a filler, water/free moisture, processing aids, deaerants, brighteners and organic polymers in a crutcher, pumping the detergent slurry to the top of a spray drying tower, and spraying the detergent slurry from nozzles in the tower to form atomized droplets. Hot air is pumped through the spray drying towers such that when the atomized droplets are sprayed into the hot air, they immediately dry into a powder as the free moisture evaporates. The spray-dried granules thus formed are then collected at the bottom of the tower.

While the spray drying conditions within the spray drying tower contain many critical variables such as temperature, air flow rate, humidity, etc., the conventional spray drying wisdom leads one to believe that adding high levels of anionic and cationic surfactants, especially anionic surfactants to the slurry prior to pumping and spray drying is highly desirable in order to result in a proper slurry. Without such a proper slurry, having the right phase, viscosity and pumping characteristics, the resulting particles will be too light, too dense, too wet, the wrong size, sticky, over hydration and thickening of the slurry, lumpy and/or possess other undesirable physical characteristics. Thus, the detergent slurries employed in typical spray drying processes contain from about 15% to about 25% organic materials, which correspond to from 20% to 40% organic materials in the final spray-dried granule. These organic materials are typically anionic and cationic surfactants, polymers, etc. However, it has been found that high levels of surfactants in the spray dried granule can limit the amount and type of other additives added, and can also limit the feasibility of additional processing. For example, adding even up to 3% nonionic surfactant to spray dried granules containing anionic surfactants often results in sticky granules which have poor flow properties, and excessive caking. Also, spray dried granules containing anionic surfactants may not have a sufficient porosity to absorb large amounts of other additives during subsequent processing. In addition, spray dried granules containing anionic surfactants may reduce formulation alternatives, as builders such as phosphate and zeolites are required because of their strong binding abilities to hard metal ions. Furthermore, such builders have certain environmental and cost limitations. Thus, while spray drying processes are known, and have been for many years, it has now been recognized that they are relatively inflexible and possess significant processing constraints.

While other methods such as agglomeration are known for making detergent compositions having other characteristics, the investment needed to set up and begin production in a new facility with a new technology is extremely prohibitive, and often outweighs the benefits sought. In addition, there are many formulation and ingredient balance restrictions in forming an agglomerate by an agglomeration process. For example, if there is too much liquid binder or not enough liquid binder, then the result will be a paste or dusting powders, respectively, as the desired agglomerates will not form efficiently.

While some may consider simply spraying inorganic raw materials with, for example, a nonionic surfactant, it has been found that this approach also results in a largely sticky and unacceptable product.

Accordingly, the need exists for a more flexible spray drying process for forming a detergent composition which overcomes the above limitations and problems, while reducing the need for significant capital investment.

### SUMMARY OF THE INVENTION

The present invention relates to an improved process for forming a detergent composition having the steps of forming a low organic slurry in a mixer, pumping the low organic slurry to a spray drying tower, spraying the low organic slurry in the spray drying tower, drying the low organic slurry in the spray drying tower to form a low organic granule, and processing the low organic granule to form a detergent composition. The low organic slurry contains less than about 10%, by weight of the low organic slurry, of an organic material. Detergent compositions formed by such a process are also provided herein.

Surprisingly, such a process forms a low organic granule having significant advantages such as improved processing flexibility, high absorption, a controllable density, granule strength, flowability, higher total water in the granule, and reduced costs, as existing spray drying facilities may be employed. In addition, it has surprisingly been found that detergent compositions formed by such a process possess acceptable flowability, low cake strength, improved cleaning, higher solubility and improved stability.

All documents cited are, in relevant part, incorporated herein by reference; the citation of any document is not to be construed as an admission that it is prior art with respect to the present invention.

### DETAILED DESCRIPTION OF THE INVENTION

All percentages, ratios and proportions herein are by weight of the final detergent composition, unless otherwise specified. All temperatures are in degrees Celsius (° C.) unless otherwise specified.

As used herein, the term “alkyl” means a hydrocarbyl moiety which is straight or branched, saturated or unsaturated. Unless otherwise specified, alkyl moieties are preferably saturated or unsaturated with double bonds, preferably with one or two double bonds. Included in the term “alkyl” is the alkyl portion of acyl groups.

As used herein, the term “comprising” means that other steps, ingredients, elements, etc. which do not affect the end result can be added. This term encompasses the terms “consisting of” and “consisting essentially of”.

As used herein, the term “water” includes both free moisture and water bound to another molecule, for example, as a hydrate.

Low Organic Slurry

A low organic slurry containing less than about 10%, preferably from about 0% to about 8%, more preferably from about 0% to about 5%, and even more preferably from about 0% to about 3%, by weight of the low organic slurry, of an organic material. Even more preferably, the low organic slurry is substantially free of an organic material, is formed in a crutcher by mixing together an organic material (if present), an inorganic material, and water to form a low organic slurry. The low organic slurry typically contains from about 28% to about 90%, preferably from about 30% to about 60%, and more preferably from about 32% to about 55% water and a viscosity of from about 500 cps (0.5 pascal seconds) to about 500,000 cps (500 pascal seconds), preferably from about 750 cps (0.75 pascal seconds) to about 100,000 cps (100 pascal seconds), and more preferably from about 1,000 cps (1 pascal seconds) to about 50,000 cps (50 pascal seconds), as measured at a shear rate of 1 s⁻¹, and a temperature of 25° C. Without intending to be limited by theory, it is believed that the water level is crucial to ensure proper mixing and homogenization of the low organic slurry. While high levels of water decrease viscosity and increase hydration, over hydration can occur, leading to thickening and even solidification of the low organic slurry. Low levels of water, in contrast, lead to increases in viscosity which create a large burden on the pumps, and equipment leading to increased equipment failure over time. High levels of water in the low organic slurry may also be desirable when making, for example, product having a low density of less than about 550 g/L.

Preferred crutcher useful herein include a draft-tube design crutcher or an impeller-design mixing blade crutcher. A preferred crutcher may contain baffles/no baffles, and/or bottom-sweep blades, as desired. Crutcher useful herein are available from, for example, Charles Ross & Son Company, Hauppauge, N.Y., USA; IKA Works, Inc. Wilmington, N.C., USA; or may be custom-made.

The organic material herein is a complex carbon and hydrogen molecule-containing material (i.e., a hydrocarbon) which is typically derived directly or indirectly from a living organism. Typical organic materials include surfactants, polymers, organic solvents, optical brighteners, organic chelants, fatty acids, organic pigments/dyes, and carboxylic acids.

The inorganic material herein is any material which does not contain complex carbon and hydrogen molecules, and typically includes inorganic salts, inorganic fillers, inorganic builders, amides, inorganic pigments/dyes, and especially the sodium, potassium, magnesium, and calcium salts of these inorganic materials, all of which are well known in the art. A highly preferred inorganic material useful herein is selected from a zeolite, sodium sulfate, sodium carbonate, potassium carbonate, sodium silicate, a sodium phosphate salt, calcium carbonate, and a combination thereof. In an even more preferred embodiment, the low organic slurry consists essentially of free moisture and an inorganic material selected from a zeolite, sodium sulfate, sodium carbonate, sodium silicate, a sodium phosphate salt, and a combination thereof. Preferred sodium phosphate salts include sodium tripolyphosphate, trisodium orthophosphate, and/or trisodium pyrophosphate.

The low organic slurry is formed in a mixer, blender, or crutcher at a temperature of from about ambient temperature to about 95° C., preferably from about 30° C. to about 90° C., and more preferably from about 35° C. to about 85° C. by employing an electrical heater, water jacket, or steam heated, as is needed. However, higher temperatures are not excluded herein as they may be desirable to produce, for example, a higher density low organic granule. After formation in the crutcher, the low organic slurry is usually moved to a drop tank from where it is pumped via a low pressure pump, through a disintegrator to a high pressure pump, and from there to the nozzle(s) which spray the low organic slurry into the spray drying tower for drying. Both batch and continuous processes are useful herein, and the low organic slurry may be maintained at the above temperatures via, for example, heating the pipes through which it is pumped. During the crutching and/or pumping processes, air and/or steam may be actively injected, or the crutcher agitation increased so as to increase the puffability of the low organic slurry to reach a preferred density of from about 0.9 g/mL to about 1.05 g/mL. Alternatively, air may have to be removed (i.e., deaeration), via, either mechanical or chemical means, to achieve the desired low organic slurry density. If sodium tripolyphosphate is present in the low organic slurry, then reversion to the hexahydrate form may be actively encouraged by adjusting the free moisture, the temperature, etc., as desired.

Spray Drying Tower

The spray drying tower useful herein is well-known in the art, and may have a single nozzle or preferably a plurality of nozzles, and more preferably from about 2 to about 6 nozzles, through which the low organic slurry is sprayed, to atomize the low organic slurry. Furthermore, the spray drying tower may contain nozzles at a single level within the spray drying tower, or at multiple levels within the spray drying tower. The nozzle may itself be heated or cooled, as desired, and may be a pressure or air atomization nozzle. If a pressure nozzle is employed, then a high pressure pump is typically provided immediately prior to the nozzle(s) so as to properly atomize the low organic slurry. Furthermore, pressure nozzles may contain different sized nozzle inserts and/or different nozzle tip openings known in the art; preferably the nozzle chamber No. 4, 5, 6, 7, 8, 10, 15, or 20, preferably nozzle chamber No.8 (inlet orifice size 4.09 mm), 10 (inlet orifice size 4.37 mm), 15 (inlet orifice size 4.04 mm×2), or 20 (inlet orifice size 4.67 mm×2), while the nozzle tip opening is from about 2 mm to abut 4 mm, preferably from about 2.5 mm to about 3.8 mm, and more preferably from about 2.7 mm to about 3.5 mm. Alternatively, a spinning disk may be used in place of at least one nozzle, and the atomization controlled by varying the spinning speed of the disk. A spinning disk is especially useful in concurrent spray drying towers.

The spraying pressure through the nozzle is highly variable and depends upon many factors such as the desired physical properties of the low organic granule, the viscosity and phase characteristics of the low organic slurry, and the equipment available. Generally, the low organic slurry will be sprayed from the nozzle(s) at a pressure of greater than about 1,000 kPa, preferably from about 1,000 kPa to about 8,000 kPa, and more preferably from about 1,500 kPa to about 6,000 kPa.

Hot air is provided in the spray drying tower, in either a concurrent or counter current direction, to dry the atomized low organic slurry to form a low organic granule. The hot air is provided by a furnace (e.g., natural gas or fuel oil) and introduced by vents into the spray tower at from about 150° C. to about 600° C., preferably from about 200° C. to about 400° C., and more preferably from about 240° C. to about 340° C. The furnace inlet vents are typically angled to provide a helical air flow within the spray drying tower. Such a helical air flow may also be produced or modified by the use of baffles within the spray tower itself. Without intending to be limited by theory, it is believed that a helical air flow is especially desirable as it increases turbulence within the spray tower, thereby resulting in improved heat transfer and drying. However, a spray drying tower having a straight-through air flow design is also useful herein.

The low organic granules formed preferably have an average particle size of from about 100 microns to about 600 microns, more preferably from about 150 microns to about 500 microns, and even more preferably from about 200 microns to about 450 microns in diameter. Furthermore, the average bulk density of the low organic granules produced is preferably from about 200 g/L to about 1000 g/L, more preferably from about 300 g/L to about 900 g/L, and even more preferably from about 400 g/L to about 800 g/L. In a preferred embodiment, oversize and undersize particles may be separated (e.g., by employing sifting and/or filtering apparatus/steps) and recycled by adding them into the crutcher to form the low organic slurry.

Surprisingly, it has also been found that the low organic granule may contain higher amounts of water than typically expected from a spray drying process, with water levels of greater than about 10% being possible, without adversely affecting the stickiness and caking of the granules. Such relatively high amounts of water provide significant advantages, as for example, less energy is needed in the spray drying process.

Without intending to be limited by theory, it is believed that by spray drying a low organic slurry, a low organic granule is formed which has high porosity and is thus able to readily absorb/wick-in other active ingredients which may be subsequently applied, as described below, preferably by spraying such actives onto the low organic granule. This process also reduces the interactions between organic material in the spray dried granule and organic material which is subsequently sprayed onto the low organic granule. Thus, it is believed that such a low organic granule allows much higher levels of, for example, nonionic surfactants to be sprayed thereupon, without resulting in a sticky, caking granule which is unacceptable by consumers. In contrast, if high levels of a nonionic surfactant is sprayed onto spray dried granules containing a high level of organic material (i.e., an anionic surfactant), the resulting granule is often sticky, prone to caking, and may also possess dissolution and gelling issues. Furthermore, spraying nonionic surfactants directly onto raw material inorganic materials produces a largely sticky and unflowable/non-flowing detergent composition. In addition, the present invention avoids the safety issues related to the use of high levels of certain organic materials (i.e., alcohols, nonionic surfactants, etc.) in a spray drying tower where temperatures are near the flash point of the organic material.

Processing to Form a Detergent Composition

Once the low organic granule is formed, additional processing is required to transform it into a detergent composition. Typically, such additional processing steps include spraying additional active ingredients onto the granule in a mixing drum, agglomerating the low organic granule to increase its size/density, passing the low organic granule through a fluid bed or other type of dryer, mixing in additional detergent components and/or dusting the low organic granule, and other steps known in the art. Forberg mixers, fluid bed dryers, and Lödige mixers may also be used herein. During such additional processing steps, additives such as dyes, pigments, perfumes, enzymes, polymers, bleaches, surfactants, silicates, etc. may be added.

Another process step which can be used to further densify the low organic granule involves treating the low organic granules in a moderate speed mixer/densifier. such as that marketed under the tradename “LÖDIGE KM™” (Series 300 or 600) or “LÖDIGE PLOUGHSHARE™” mixer/densifiers and/or the “DRAIS K-T 160™”. “SCHUGI™” and “TURBULIZER™” mixers from BEPEX Corporation are also useful. Such equipment is typically operated at 40-160 rpm. The residence time of the detergent ingredients in the moderate speed mixer/densifier is from about 0.1 to about 12 minutes conveniently measured by dividing the steady state mixer/densifier weight by the throughput (e.g., kg/hr). This process step which employs a moderate speed mixer/densifier (e.g. Lödige KM) can be used by itself or sequentially with a high speed mixer/densifier (e.g. Lödige CB) to achieve the desired density. Other types of granules manufacturing apparatus useful herein include the apparatus disclosed in U.S. Pat. No. 2,306,898, to Heller, issued on Dec. 29, 1942.

While it may be more suitable to use the high speed mixer/densifier followed by the low speed mixer/densifier, the reverse sequential mixer/densifier configuration also can be used. One or a combination of various parameters including residence times in the mixer/densifiers, operating temperatures of the equipment, temperature and/or composition of the granules, the use of adjunct ingredients such as liquid binders and flow aids, can be used to optimize densification of the spray-dried granules in the process of the invention. By way of example, see the processes in Appel, et al., U.S. Pat. No. 5,133,924, issued Jul. 28, 1992; Delwel, et al., U.S. Pat. No. 4,637,891, issued Jan. 20, 1987; Kruse, et al., U.S. Pat. No. 4,726,908, issued Feb. 23, 1988; and Bortolotti, et al., U.S. Pat. No. 5,160,657, issued Nov. 3, 1992.

Optionally, high density detergent compositions according to the invention may be produced by blending conventional or densified low organic granules with detergent agglomerates in various proportions (e.g. a 60:40 weight ratio of granules to agglomerates) produced by one or a combination of the processes discussed herein. See U.S. Pat. No. 5,569,645 to Dinniwell, et al., issued Oct. 29, 1996. Additional adjunct ingredients such as enzymes, perfumes, brighteners and the like can be sprayed or admixed with the agglomerates, granules or mixtures thereof produced by the processes discussed herein.

In a highly preferred embodiment, the low organic granule is sprayed with a nonionic surfactant, a polymer, an anionic surfactant, and/or a silicate in a drum mixer or a fluid bed, to produce a detergent composition. If present, the level of nonionic surfactant which may be sprayed onto the low organic granule is from about 0.05% to about 50%, preferably from about 0.1% to about 40%, more preferably from about 0.5% to about 25%, and even more preferably from about 4% to about 20% by weight of the low organic granule. Such a granule has good flowability, improved dissolution, low cake strength, high water hardness tolerance, good cleaning performance, and/or high product stability.

Nonionic surfactants useful herein are generally disclosed in U.S. Pat. No. 3,929,678 to Laughlin, et al., issued Dec. 30, 1975, at column 13, line 14 through column 16, line 6. Other nonionic surfactants useful herein include the condensation products of aliphatic alcohols with from about 1 to about 25 moles of ethylene oxide. The alkyl chain of the aliphatic alcohol can either be straight or branched, primary or secondary, and generally contains from about 8 to about 22 carbon atoms. Particularly preferred are the condensation products of alcohols having an alkyl group containing from about 10 to about 20 carbon atoms with from about 2 to about 18 moles of ethylene oxide per mole of alcohol. Examples of commercially available nonionic surfactants of this type include TERGITOL® 15-S-9 (the condensation product of C₁₁-C₁₅ linear secondary alcohol with 9 moles ethylene oxide), TERGITOL® 24-L-6 NMW (the condensation product of C₁₂-C₁₄ primary alcohol with 6 moles ethylene oxide with a narrow molecular weight distribution), both marketed by Union Carbide Corporation; NEODOL® 45-9 (the condensation product of C₁₄-C₁₅ linear alcohol with 9 moles of ethylene oxide), NEODOL® 23-6.5 (the condensation product of C₁₂-C₁₃ linear alcohol with 6.5 moles of ethylene oxide), NEODOL® 45-7 (the condensation product of C₁₄-C₁₅ linear alcohol with 7 moles of ethylene oxide), NEODOL® 45-4 (the condensation product of C₁₄-C₁₅ linear alcohol with 4 moles of ethylene oxide), marketed by Shell Chemical Company, and KYRO® EOB (the condensation product of C₁₃-C₁₅ alcohol with 9 moles ethylene oxide), marketed by The Procter & Gamble Company, Cincinnati, Ohio, U.S.A. Other commercially available nonionic surfactants include DOBANOL 91-8® marketed by Shell Chemical Co. and GENAPOL UD-080® marketed by Hoechst. This category of nonionic surfactant is referred to generally as “alkyl ethoxylates.” Also useful herein is a nonionic surfactant selected from the group consisting of an alkyl polyglycoside surfactant, a fatty acid amide surfactant, a C₈-C₂₀ ammonia amide, a monoethanolamide, a diethanolamide, an isopropanolamide, and a mixture thereof. Such nonionic surfactants are known in the art, and are commercially-available.

The amphoteric surfactant herein is preferably selected from the various amine oxide surfactants. Amine oxides are semi-polar nonionic surfactants and include water-soluble amine oxides containing one alkyl moiety of from about 10 to about 18 carbon atoms and 2 moieties selected from the group consisting of alkyl groups and hydroxyalkyl groups containing from about 1 to about 3 carbon atoms; water-soluble phosphine oxides containing one alkyl moiety of from about 10 to about 18 carbon atoms and 2 moieties selected from the group consisting of alkyl groups and hydroxyalkyl groups containing from about 1 to about 3 carbon atoms; and water-soluble sulfoxides containing one alkyl moiety of from about 10 to about 18 carbon atoms and a moiety selected from the group consisting of alkyl and hydroxyalkyl moieties of from about 1 to about 3 carbon atoms.

Preferred amine oxide surfactants have the formula:

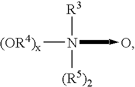

where R³ is an alkyl, a hydroxyalkyl, an alkyl phenyl group or a mixture thereof containing from about 8 to about 22 carbon atoms; R⁴ is an alkylene or hydroxyalkylene group containing from about 2 to about 3 carbon atoms or mixtures thereof; x is from 0 to about 3; and each R⁵ is an alkyl or a hydroxyalkyl group containing from about 1 to about 3 carbon atoms or a polyethylene oxide group containing from about 1 to about 3 ethylene oxide groups. The R⁵ groups can be attached to each other, e.g., through an oxygen or nitrogen atom, to form a ring structure. Preferred amine oxide surfactants include the C₁₀-C₁₈ alkyl dimethyl amine oxides and the C₈-C₁₂ alkoxy ethyl dihydroxy ethyl amine oxides.

Also suitable are amine oxides such as propyl amine oxides, represented by the formula:

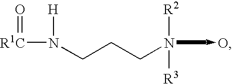

where R¹ is an alkyl, 2-hydroxyalkyl, 3-hydroxyalkyl, or 3-alkoxy-2-hydroxypropyl radical in which the alkyl and alkoxy, respectively, contain from about 8 to about 18 carbon atoms, R₂ and R³ are each methyl, ethyl, propyl, isopropyl, 2-hydroxyethyl, 2-hydroxypropyl, or 3-hydroxypropyl and n is from 0 to about 10.

A further suitable species of amine oxide semi-polar surface active agents comprise compounds and mixtures of compounds having the formula:

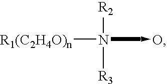

where R₁ is an alkyl, 2-hydroxyalkyl, 3-hydroxyalkyl, or 3-alkoxy-2-hydroxypropyl radical in which the alkyl and alkoxy, respectively, contain from about 8 to about 18 carbon atoms, R₂ and R₃ are each methyl, ethyl, propyl, isopropyl, 2-hydroxyethyl, 2-hydroxypropyl, or 3-hydroxypropyl and n is from 0 to about 10. Particularly preferred are amine oxides of the formula:

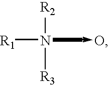

where R₁ is a C₁₀₋₁₄ alkyl and R₂ and R₃ are methyl or ethyl. Because they are low-foaming it may also be particularly desirable to use long chain amine oxide surfactants which are more fully described in U.S. Pat. No. 4,316,824 to Pancheri, granted on Feb. 23, 1982; U.S. Pat. No. 5,075,501 to Borland and Smith, granted on Dec. 24, 1991; and U.S. Pat. No. 5,071,594 to Borland and Smith, granted on Dec. 10, 1991.

Other suitable, non-limiting examples of the amphoteric surfactant useful in the present invention includes amido propyl betaines and derivatives of aliphatic or heterocyclic secondary and ternary amines in which the aliphatic moiety can be straight chain, or branched and wherein one of the aliphatic substituents contains from about 8 to about 24 carbon atoms and at least one aliphatic substituent contains an anionic water-solubilizing group.

Further examples of suitable amphoteric surfactants are disclosed in “Surface Active Agents and Detergents” (Vol. I and II by Schwartz, Perry and Berch).

Anionic surfactants useful herein include the conventional C₁₁-C₁₈ alkyl benzene sulfonates (“LAS”) and primary, branched-chain and random C₁₀-C₂₀ alkyl sulfates (“AS”), the C₁₀-C₁₈ secondary (2,3) alkyl sulfates of the formula CH₃(CH₂)ₓ(CHOSO₃⁻M⁺) CH₃ and CH₃ (CH₂)_{y}(CHOSO₃⁻M⁺) CH₂CH₃ where x and (y+1) are integers of at least about 7, preferably at least about 9, and M is a water-solubilizing cation, especially sodium, unsaturated sulfates such as oleyl sulfate, the C₁₀-C₁₈ alkyl alkoxy sulfates (“AE_{X}S”; especially EO 1-7 ethoxy sulfates), sulfated polyglycosides, and C₁₂-C₁₈ alpha-sulfonated fatty acid esters, all of which are known in the art. Such surfactants are typically present at levels of at least about 1%, preferably from about 1% to about 55%.

Typical polymers useful herein include polymeric soil release agents, polymeric dispersing agents, clay soil removal/anti-redeposition agents, dye transfer inhibition agents, suds suppressers, and suds enhancers. Exemplary ethoxylated amines are described in U.S. Pat. No. 4,597,898 to VanderMeer, issued Jul. 1, 1986. Another group of preferred clay soil removal/anti-redeposition agents are the cationic compounds disclosed in European Patent Application 111 965 to Oh and Gosselink, published Jun. 27, 1984. Other useful clay soil removal/antiredeposition agents include the ethoxylated amine polymers disclosed in European Patent Application 111984 to Gosselink, published Jun. 27, 1984; the zwitterionic polymers disclosed in European Patent Application 112 592 to Gosselink, published Jul. 4, 1984; and the amine oxides disclosed in U.S. Pat. No. 4,548,744 to Connor, issued Oct. 22, 1985. Other clay soil removal and/or anti redeposition agents known in the art can also be utilized in the compositions herein. Another type of preferred antiredeposition agent includes the carboxy methyl cellulose materials. These materials are well known in the art. Generally, dye transfer inhibiting agents include polyvinyl pyrrolidone polymers, polyamine N-oxide polymers, copolymers of N-vinylpyrrolidone and N-vinylimidazole, manganese phthalocyanine, peroxidases, and mixtures thereof. If used, these agents typically comprise from about 0.01% to about 10% by weight of the composition, preferably from about 0.01% to about 5%, and more preferably from about 0.05% to about 2%. See, for example, EP-A-262,897 to Hull and Scowen, published Apr. 6, 1988 and EP-B-256,696 to Hull, issued Dec. 13, 1989.

Enzymes may also be useful herein, and are typically added as enzyme prills during a dry admix stage. Enzymes can be included in the present detergent compositions for a variety of purposes, including removal of protein-based, carbohydrate-based, or triglyceride-based stains from substrates, for the prevention of refugee dye transfer in fabric laundering, and for fabric restoration. Suitable enzymes include proteases, amylases, lipases, cellulases, peroxidases, and mixtures thereof of any suitable origin, such as vegetable, animal, bacterial, fungal and yeast origin. Preferred selections are influenced by factors such as pH-activity and/or stability optima, thermostability, and stability to active detergents, builders and the like. In this respect bacterial or fungal enzymes are preferred, such as bacterial amylases and proteases, and fungal cellulases. Enzymes are normally incorporated into detergent or detergent additive compositions at levels sufficient to provide a “cleaning-effective amount”. The term “cleaning effective amount” refers to any amount capable of producing a cleaning, stain removal, soil removal, whitening, deodorizing, or freshness improving effect on substrates such as fabrics, dishware and the like. In practical terms for current commercial preparations, typical amounts are up to about 5 mg by weight, more typically 0.01 mg to 3 mg, of active enzyme per gram of the detergent composition. Stated otherwise, the compositions herein will typically comprise from 0.001% to 5%, preferably 0.01%-1% by weight of a commercial enzyme preparation. Protease enzymes are usually present in such commercial preparations at levels sufficient to provide from 0.005 to 0.1 Anson units (AU) of activity per gram of composition.

Suitable examples of proteases are the subtilisins which are obtained from particular strains of B. subtilis and B. licheniformis. One suitable protease is obtained from a strain of Bacillus, having maximum activity throughout the pH range of 8-12, developed and sold as ESPERASE® by Novo Industries A/S of Denmark, hereinafter “Novo”. Other suitable proteases include ALCALASE® and SAVINASE® from Novo and MAXATASE® from International Bio-Synthetics, Inc., The Netherlands; see also the proteases disclosed in EP 130,756 A to Bott, published Jan. 9, 1985; EP 303,761 B, to Post, et al., issued Sep. 9, 1992; WO 9318140 A1 to Aaslyng et al., published Sep. 16, 1993; WO 9510591 A1 to Baeck et al., published Apr. 20, 1995; WO 9507791 A1 to Gerber, published Mar. 23, 1995; and WO 9425583 to Branner et al., published Nov. 10, 1994.

Amylases suitable herein include, for example, a-amylases described in GB 1,296,839 to Outtrup, et al., published Nov. 22, 1972 to Novo; RAPIDASE®, International Bio-Synthetics, Inc.; TERMAMYL® from Novo; FUNGAMYL® from Novo; DURAMYL®, from Novo; the amylases described in: WO 9402597 to Bisgard-Frantzen and Svendsen, published Feb. 3, 1994; WO 9418314 to Antrim, et al., to Genencor International, published Aug. 18, 1994; WO 9402597 to Bisgard-Frantzen and Svendsen, published Feb. 3, 1994; and WO 9509909 A to Borch, et al., published Apr. 13, 1995.

Cellulases useful herein are disclosed in GB-B-2.075.028 to Barbesgaar, et al., issued Mar. 28, 1984; GB-B-2.095.275 to Murata, et al., issued Aug. 7, 1985 date as 095275 and DE-OS-2.247.832 to Horikoshi and Ikeda, issued June 27 1974. CAREZYME® and CELLUZYME® (Novo) are especially useful. See also WO 9117243 to Hagen, et al., published Nov. 14, 1991 as to Novo.

Lipases useful herein include those disclosed in GB 1,372,034 to Dijk and Berg, published Oct. 30, 1974; Japanese Patent Application 53,20487 to Inugai, published Feb. 24, 1978 (available from Amano Pharmaceutical Co. Ltd., Nagoya, Japan, under the trade name Lipase P “Amano” or “Amano-P”); LIPOLASE® commercially available from Novo; EP 341,947 to Cornelissen, et al., issued Aug. 31, 1994; WO 9414951 to Halkier, et al., published Jul. 7, 1994 A to Novo; and WO 9205249 to Clausen, et al., published Apr. 2, 1992.

Peroxidase enzymes and enzyme stabilizing systems may also be useful herein.

The detergent compositions herein may optionally comprise other known detergent cleaning components at levels of from about 0.01% to about 10%, including alkoxylated polycarboxylates, bleaching compounds, brighteners, chelating agents, dye transfer inhibiting agents, enzymes, enzyme stabilizing systems, and/or fabric softeners. Such components are typically added to the low organic granule in an admix, or as spray-on components, as is appropriate.

Additional optional spray drying apparatuses and processes are described in, for example, U.S. Pat. No. 5,496,487 to Capeci, et al., issued on Mar. 5, 1996; U.S. Pat. No. 4,963,226 to Chamberlain, issued on Oct. 16, 1990; and U.S. Pat. No. 4,129,511 to Ogoshi, et al., issued on Dec. 12, 1978.

Cake strength can be measured by methods known in the art, such as described in U.S. Pat. No. 4,290,903 to Macgilp and Mann, issued on Sep. 22, 1981 at col. 6, lines 29-42. Flowability is tested via a Hosokawa Powder Characteristics Tester type PT-E.

### EXAMPLE 1

Sodium silicate, sodium carbonate, sodium sulfate, polymeric material, 40% water, by weight of the low organic slurry, and optical brightener are mixed in a crutcher at about 40° C. until evenly blended to form a low organic slurry containing about 1% organic material, by weight of the low organic slurry. This was passed to a drop tank, passed through a strainer, and pumped to a spray drying tower having 2 pressure nozzles arranged in a counter-current, straight air-flow configuration. The nozzle chamber is a No. 10 (inlet orifice size 4.37 mm), 15 (inlet orifice size 4.04 mm×2), or 20 (inlet orifice size 4.67 mm x 2) and the nozzle tip opening has a diameter of 2.77 mm. The air inlet has a temperature of from 270-340° C., and the spraying pressure was about 2,000 kPa. The tower outlet temperature was about 70-90° C. The low organic granules thus produced have an average particle size of about 396 microns in diameter, and an average bulk density of about 486 μL. The resulting low organic granule has a water content of about 8-9%, and an organic material content of less than 3%.

The low organic granules are admixed with additional sodium carbonate and miscellaneous particles. These ingredients are then combined in a mixer where zeolite is added while perfume and nonionic surfactant are sprayed, resulting in a detergent composition containing 10% nonionic surfactant.

The final detergent composition has low cake strength, a high water content, high solubility, good cleaning characteristics, and excellent flowability.

### EXAMPLE 2

A low organic granule is produced as in Example 1, except that some of the organic materials are premixed with 6.5% sodium carbonate prior to addition to the 1^{st} crutcher. To compensate, in the admixing step, the amount of sodium carbonate is correspondingly reduced. The remaining organic materials are added directly to the 1^{st} crutcher, which passes the low organic slurry to a 2^{nd} crutcher.

A different spray tower is used, having 6 nozzles, and a higher pressure pump. Thus, the spraying pressure is from 2,800-5,300 kPa. The nozzle chamber No. 8 (inlet orifice size 4.09 mm), and the nozzle tip opening size has 5 nozzles having a 3 mm diameter and 1 nozzle having a 3.28 mm diameter. The low organic slurry temperature is, about 65° C. The average tower air inlet temperature is about 250-370° C. and the average tower outlet temperature is about 70-115° C. The low organic granules thus produced have an average particle size of about 256 microns in diameter, and an average bulk density of about 480 g/L. The resulting low organic granule has a water content of about 8-9%, and an organic material content of less than 3%.

The final detergent composition has low cake strength, a high water content, high solubility, good cleaning characteristics, and excellent flowability.

### EXAMPLE 3

Sodium silicate, sodium carbonate, sodium sulfate, polymeric material, 35% water, by weight of the low organic slurry, and optical brightener are mixed in a crutcher at 50° C. until evenly blended to form a low organic slurry containing 6% organic material, by weight of the low organic slurry. This was passed to a drop tank, passed through a strainer, and pumped to a spray drying tower having 8 pressure nozzles arranged in a counter-current, straight air-flow configuration. The nozzle chamber is a No. 8 (inlet orifice size 4.09 mm) and the nozzle tip opening has a diameter of 2.77 mm. The air inlet has a temperature of from 300-340° C., and the spraying pressure was from 3,000 to 4,000 kPa. The tower outlet temperature was 70-80° C. The low organic granules thus produced have an average particle size of 290-360 microns in diameter, and an average bulk density of 550 g/L. The resulting low organic granule has a water content of 2-6%, and an organic material content of less than 8.5%. The low organic granules are admixed with additional sodium carbonate and miscellaneous particles. These ingredients are then combined in a mixer where zeolite is added while perfume and nonionic surfactant are sprayed, resulting in a detergent composition containing 6.5% nonionic surfactant.

The final detergent composition has low cake strength, a high water content, high solubility, good cleaning characteristics, and excellent flowability.

### EXAMPLE 4

The process of Example 3 is employed to make detergent compositions having the following formulas, all percentages are by weight of the final detergent composition:

| | Formula A | Formula B |
|---|---|---|
| Crutcher ingredients | | |
| Anionic surfactant | 8 | 12 |
| Soil suspension polymer | 1.2 | — |
| Carboxymethyl cellulose | 0.4 | 0.2 |
| Optical brightener | 0.2 | 0.2 |
| Sodium silicate | 6 | 8 |
| Sodium sulfate | 62 | 57 |
| Admix ingredients | | |
| Sodium sulfate | 5 | 10 |
| Sodium carbonate | 10 | 6 |
| Nonionic surfactant (sprayed on) | 5.4 | 5 |
| Perfume, minors, moisture | Balance | Balance |

In the crutcher at a crutcher mix moisture of 35%, the low organic slurry of Formula A contains 8% organic material by weight of the organic slurry, whereas the low organic slurry of Formula B contains 10% organic material by weight of the organic slurry. Similar runs conducted at a crutcher mix moisture of 40% (see the process of Example 1) result in the low organic slurry of Formula A containing 7.3% organic material by weight of the organic slurry, whereas the low organic slurry of Formula B contains 9.1% organic material by weight of the organic slurry. The final detergent compositions have low cake strength, high solubility, good cleaning characteristics, and excellent flowability.

### EXAMPLE 5

Detergent compositions are made according to Example 4, except that the soil suspension polymer level is varied from 0-0.8%, the carboxymethyl cellulose level is varied from 0.2-0.4%, up to 1% zeolite is added in the admix, and the nonionic surfactant level is varied from 5-5.4%. The final detergent compositions have low cake strength, high solubility, good cleaning characteristics, and excellent flowability.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A process for forming a detergent composition comprising the steps of:
A. forming a low organic slurry comprising less than about 10%, by weight of the low organic slurry, of an organic material in a mixer;
B. pumping the low organic slurry to a spray drying tower;
C. spraying the low organic slurry in the spray drying tower;
D. drying the low organic slurry in the spray drying tower to form a low organic granule; and
E. processing the low organic granule to form a detergent composition.

2. The process according to claim 1, wherein the low organic slurry comprises from about 0% to about 8%, by weight of the low organic slurry, of an organic material.

3. The process according to claim 1, wherein the processing step comprises the step of spraying the low organic granule with a surfactant selected from the group consisting of an anionic surfactant, an amphoteric surfactant, a cationic surfactant a nonionic surfactant, a zwitterionic surfactant and a mixture thereof.

4. The process according to claim 1, wherein the low organic slurry comprises an inorganic material selected from the group consisting of a carbonate, a phosphate, a silicate, a sulfate, a zeolite and a mixture thereof.

5. The process according to claim 1, wherein the spray drying tower is a counter-current spray drying tower.

6. The process according to claim 1, wherein the spray drying tower comprises a plurality of nozzles located at a plurality of different locations in the spray drying tower.

7. The process according to claim 2, wherein the low organic slurry comprises from about 0% to about 5%, by weight of the low organic slurry, of an organic material, and wherein the low organic slurry comprises an inorganic material selected from the group consisting of a carbonate, a phosphate, a silicate, a sulfate, a zeolite and a mixture thereof.

8. The process according to claim 3, wherein the surfactant comprises from about 4% to about 20% of a nonionic surfactant, by weight of the final detergent composition.

9. The process according to claim 7, wherein the low organic slurry consists essential of an inorganic material selected from the group consisting of a carbonate, a phosphate, a silicate, a sulfate, a zeolite and a mixture thereof.

10. A detergent composition formed by a process according to claim 1.
